(19) United States
(12) Patent Application Publication
(10) Pub. No.: US 2021/0287621 A1
(43) Pub. Date: Sep. 16, 2021

(54) DISPLAY PANEL

(71) Applicant: Sharp Kabushiki Kaisha, Sakai City, Osaka (JP)

(72) Inventors: Kohhei TANAKA, Sakai City (JP); Takayuki NISHIYAMA, Sakai City (JP); Ryo YONEBAYASHI, Sakai City (JP); Tokihiro YOKONO, Sakai City (JP)

(21) Appl. No.: 16/336,492

(22) PCT Filed: Sep. 22, 2017
(86) PCT No.: PCT/JP2017/034243

§ 371 Date: Mar. 26, 2019

(30) Foreign Application Priority Data
Sep. 27, 2016 (JP) 2016-188617

(51) Int. Cl. G09G 3/36

(52) U.S. Cl. CPC G09G 3/3648; G09G 2300/08; G09G 2330/021

(57) ABSTRACT

An active matrix substrate 10 configuring the display panel includes a plurality of gate lines provided in each of pixel segments Snm arrayed in a matrix form, and a plurality of data lines crossing the gate lines. The pixel segments Snm are provided respectively with gate line drive circuitry 13. Each of the gate line drive circuitry 13 is connected to drive control lines 152 and 153 that are supplied with drive control signals Sxm and Sym commanding drive or stop of the gate line drive circuitry. The gate line drive circuitry 13 having received the drive control signal commanding drive scans the gate lines in the pixel segment including the gate line drive circuitry 13.

### TECHNICAL FIELD

The present invention relates to a display panel.

### BACKGROUND ART

WO 2014/069529 A discloses a display device including an active matrix substrate having a plurality of gate lines disposed in each of segmented regions divided in parallel with data lines, and a plurality of gate drivers configured to scan the gate lines and disposed in each of the segmented regions provided with the gate lines. The gate drivers each receive a row selection signal as a command to switch a corresponding one of the gate lines into a selected state or an unselected state. Each of the gate drivers receives a row selection signal at a high (H) voltage level in order to switch the gate line into the selected state, whereas the gate driver receives a row selection signal at a low (L) voltage level in order to switch the gate line into the unselected state. All the gate drivers disposed in an identical one of the segmented regions are sequentially driven in accordance with a supplied control signal. In the gate drivers disposed in the identical segmented region, the gate driver having received the row selection signal at the H level outputs, to the gate line, a voltage signal bringing the gate line into the selected state. In contrast, the gate driver having received the row selection signal at the L level outputs, to the gate line, a voltage signal bringing the gate line into the unselected state.

### DISCLOSURE OF INVENTION

WO 2014/069529 A achieves switching only a gate line in a specific region into the selected state in accordance with a row selection signal. This enables data to be written to the specific region at a frequency different from a frequency for a remaining region. However, according to WO 2014/069529 A, all the gate drivers disposed in the identical segmented region are driven regardless of whether the row selection signal has the H voltage level or the L voltage level. The gate driver for the gate line to be brought into the selected state as well as the gate driver for the gate line to be brought into the unselected state are driven in this configuration that accordingly needs electric power for driving all the gate drivers.

It is an object of the present invention to provide a display panel enabling reduction in electric power consumed by a drive unit configured to scan gate lines.

A display panel according to an aspect of the present invention includes an active matrix substrate, in which the active matrix substrate includes: a substrate; a plurality of gate lines provided in a plurality of pixel segments arrayed in a matrix form on the substrate, including a plurality of gate lines provided in each of the pixel segments; a plurality of data lines crossing the plurality of gate lines; a plurality of gate line drive circuitry provided respectively in the plurality of pixel segments; and a drive control line connected to each of the gate line drive units to be supplied with a drive control signal indicating drive or stop of the gate line drive circuitry; and at least one gate line drive circuitry connected to the drive control line having been supplied with the drive control signal indicating drive scans the plurality of gate lines in the pixel segment provided with the at least one gate line drive circuitry.

The above configuration enables reduction in electric power consumed by the drive units configured to scan the gate lines.

### BRIEF DESCRIPTION OF DRAWINGS

FIG. 1 is a sectional view of a display device according to a first embodiment.

FIG. 2A is a plan view showing a schematic configuration of an active matrix substrate 10 shown in FIG. 1.

FIG. 2B is an enlarged pattern diagram of part of pixel segments shown in FIG. 2A.

FIG. 3A is a pattern diagram showing a gate line drive unit provided in each pixel segment Snm shown in FIG. 2A, and control signals received by a terminal part.

FIG. 3B is a pattern diagram showing a configuration of the gate line drive unit in each of the pixel segments Snm shown in FIG. 3A.

FIG. 4 is an equivalent circuit diagram of gate drivers included in the gate line drive unit in the pixel segment Snm.

FIG. 5 is a pattern diagram showing exemplary disposition of gate drivers 130(1) to 130(k) in the pixel segment Snm.

FIG. 6 is a timing chart indicating potential variation of drive control signals, clock signals, a reset signal, internal lines netA in the gate drivers 130(1) to 130(k), and gate lines GL(1) to GL(k).

FIG. 7 is a timing chart of drive control signals, clock signals, and reset signals upon having data written to a pixel segment S23 shown in FIG. 2A.

FIG. 8 is a timing chart of drive control signals, clock signals, and reset signals upon having data written to the pixel segment S23 and a pixel segment S45 shown in FIG. 2A.

FIG. 9 is a timing chart of drive control signals, clock signals, and reset signals upon having data written to all the pixel segments shown in FIG. 2A.

FIG. 10 is a plan view showing a schematic configuration of an active matrix substrate according to a second embodiment.

FIG. 11 is a timing chart of drive control signals, clock signals, and reset signals upon having data written to the pixel segment S23 shown in FIG. 2A in the second embodiment.

FIG. 12 is a timing chart of drive control signals, clock signals, and reset signals upon having data written to the pixel segment S23 and the pixel segment S45 shown in FIG. 2A in the second embodiment.

FIG. 13 is an explanatory diagram on part of pixel segments having data writing updated during each frame in a third embodiment.

FIG. 14 is a timing chart indicating data writing to respective pixel segments in an active matrix substrate shown in FIG. 13.

### DESCRIPTION OF EMBODIMENTS

A display panel according to an embodiment of the present invention includes an active matrix substrate, in which the active matrix substrate includes: a substrate; a plurality of gate lines provided in a plurality of pixel segments arrayed in a matrix form on the substrate, including a plurality of gate lines provided in each of the pixel segments; a plurality of data lines crossing the plurality of gate lines; a plurality of gate line drive circuitry provided respectively in the plurality of pixel segments; and a drive control line connected to each of the gate line drive units to be supplied with a drive control signal indicating drive or stop of the gate line drive circuitry; and at least one gate line drive circuitry connected to the drive control line having been supplied with the drive control signal indicating drive scans the plurality of gate lines in the pixel segment provided with the at least one gate line drive circuitry (a first configuration).

According to the first configuration, the pixel segments are each provided with the plurality of gate lines and the gate line drive circuitry configured to scan the gate lines. The gate line drive circuitry is connected to the drive control line that is supplied with the drive control signal indicating drive or stop of the gate line drive circuitry. The gate line drive circuitry having received the drive control signal indicating drive scans the gate lines in the pixel segment including the gate line drive circuitry. The gate line drive circuitry to be driven is determined in accordance with the drive control signal. The gate line drive circuitry can thus be each driven in a corresponding one of the pixel segments so as to scan the gate lines in the pixel segment. The gate line drive circuitry in the pixel segment not to have data written thereto can then be stopped for a certain period to reduce electric power consumed for driving the gate line drive circuitry.

Optionally, in the first configuration, the active matrix substrate further includes a plurality of drive lines connected respectively to the plurality of gate line drive circuitry to each supply a drive signal used for scanning the gate lines by a corresponding one of the gate line drive circuitry, and the drive lines are simultaneously supplied with the drive signal in common (a second configuration).

According to the second configuration, the common drive signal is simultaneously supplied to each of the gate line drive circuitry in all the pixel segments. Even in such a case where the common drive signal is simultaneously supplied to each of the gate line drive circuitry in all the pixel segments, the gate line drive circuitry supplied with no drive control signal indicating drive is not driven. Also in the present configuration, the gate line drive circuitry in the pixel segment not to have data written thereto can be stopped for a certain period to reduce electric power consumed for driving the gate line drive circuitry.

Optionally, in the first configuration, the active matrix substrate further includes a plurality of drive lines each provided for each column of the plurality of pixel segments, connected to the gate line drive circuitry provided in the column, and configured to supply a drive signal used for scanning the gate lines by the gate line drive circuitry, and the drive signal is supplied only to the drive line connected to the gate line drive circuitry in the column of the pixel segments provided with the gate line drive circuitry receiving the drive control signal indicating drive (a third configuration).

According to the third configuration, the drive signal is supplied only to each of the gate line drive circuitry provided in the column of the pixel segments to have data written thereto. This configuration achieves reduction in electric power consumed for supplying the drive signal, in comparison to a case where the drive signal is supplied also to the pixel segments in the column not to have data written thereto.

In any one of the first to third configurations, the gate line drive circuitry provided in the plurality of pixel segments arrayed in each row may be simultaneously supplied with the drive control signal in common (a fourth configuration).

The fourth configuration enables the gate line drive circuitry provided in the pixel segments in the same row to be driven simultaneously. The gate lines in the pixel segments in the same row can thus be scanned simultaneously and data can be written by the row of the pixel segments.

In any one of the first to third configurations, the plurality of gate line drive circuitry may be simultaneously supplied with the drive control signal in common (a fifth configuration).

The fifth configuration enables the gate line drive circuitry disposed in the plurality of pixel segments to be driven simultaneously. The gate lines in all the pixel segments can thus be scanned simultaneously and same data can be written simultaneously to all the pixel segments. When the same data is written to all the pixel segments, this configuration achieves reduction in time for supplying the drive signal and reduction in electric power consumed for the supplying the drive signal, in comparison to a case where the gate line drive circuitry are driven by the row of the pixel segments.

Embodiments of the present invention will now be described in detail below with reference to the drawings. Identical or corresponding portions in the drawings will be denoted by identical reference signs and will not be described repeatedly.

### First Embodiment

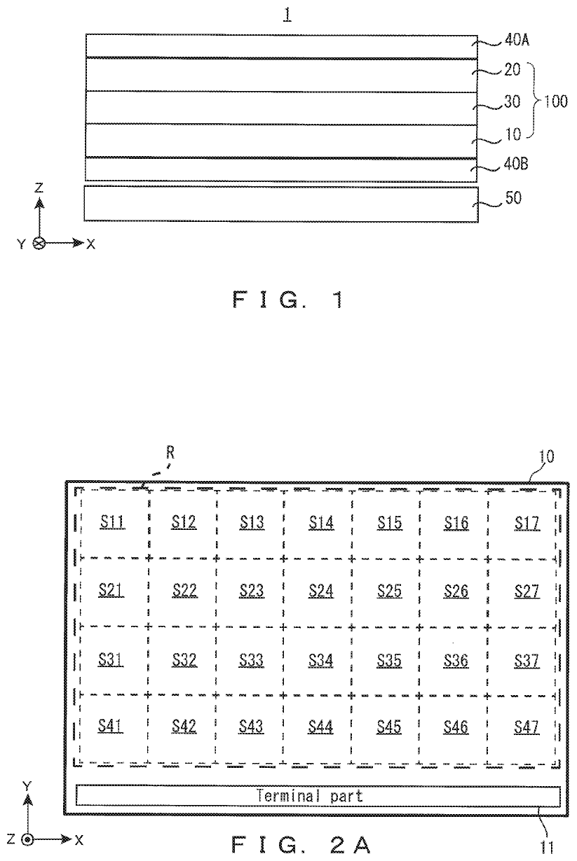

FIG. 1 is a sectional view showing a schematic configuration of a display device according to the present embodiment. A display device 1 includes a display panel 100 having an active matrix substrate 10, a counter substrate 20, and a liquid crystal layer 30 interposed between the active matrix substrate 10 and the counter substrate 20, a pair of polarizing plates 40A and 40B, and a backlight unit 50. The display panel 100 according to the present embodiment is configured by a transmissive liquid crystal panel, and the active matrix substrate 10 and the counter substrate 20 each have a rectangular shape.

The counter substrate 20 is provided, on a surface adjacent to the liquid crystal layer 30, with a black matrix, color filters for three colors of red (R), green (G), and blue (B), and a common electrode (all not shown). The common electrode is not needed in a case where the liquid crystal layer 30 is oriented in a fringe field switching (FFS) mode.

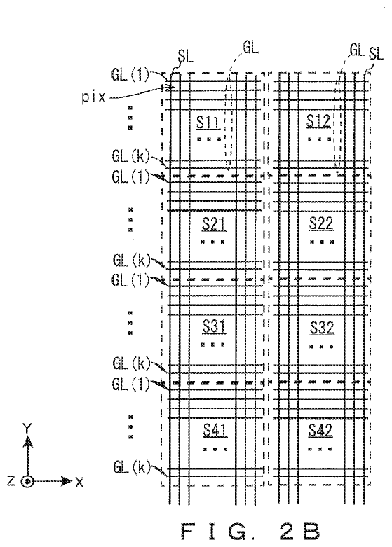

FIG. 2A is a plan view showing a schematic configuration of the active matrix substrate 10 shown in FIG. 1. The active matrix substrate 10 is provided, on a substrate made of glass or the like, with a display region R including a plurality of pixel segments Snm arrayed in a matrix form having n (n is an integer) rows and m (m is an integer) columns. The active matrix substrate 10 exemplified herein is provided, on the substrate, with 28 pixel segments Snm (1≤n≤4, 1≤m≤7) having four rows and seven columns. The 28 pixel segments each include a plurality of pixels. The active matrix substrate 10 includes a terminal part 11 disposed outside the display region R. The terminal part 11 is connected to a display control circuit (not shown) configured to supply an image display control signal or the like. Although not shown in FIG. 2A, the active matrix substrate 10 has a side that is provided with the terminal part 11 and is connected to a source driver provided on a flexible substrate or the like and configured to supply a data signal.

FIG. 2B is an enlarged pattern diagram of the pixel segments S11 to S41 and S12 to S42 arrayed in first and second columns shown in FIG. 2A. As shown in FIG. 2B, the pixel segments are each provided with k gate lines GL (GL(1) to GL(k)). As in FIG. 2B, the gate lines GL in the pixel segments adjacent to each other in an X-axis direction are distant from each other so as to be disposed independently in each of the segments. There is provided a plurality of data lines SL crossing the gate lines GL(1) to GL(k). The pixel segments each include a plurality of pixels pix defined by the gate lines GL(1) to GL(k) and the data lines SL disposed in the corresponding pixel segment.

The data lines SL are connected to the source driver (not shown) so as to each receive a data signal from the source driver. The gate lines GL in each of the pixel segments are scanned by a gate line drive unit provided in the pixel segment. Described below is the gate line drive unit provided in the pixel segment Snm.

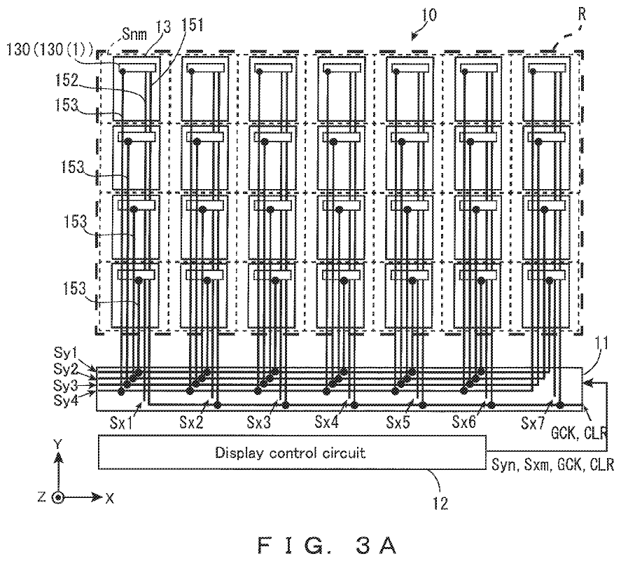

FIG. 3A is a pattern diagram showing the gate line drive unit provided in each of the pixel segments Snm shown in FIG. 2A, and control signals received by the terminal part 11. This figure shows neither the gate lines GL nor the data lines SL.

As shown in FIG. 3A, the pixel segments Snm are each provided with a gate line drive unit 13. FIG. 3B is a pattern diagram showing a configuration of the gate line drive unit 13 in one of the pixel segments Snm. As shown in FIG. 3B, the gate line drive unit 13 includes k gate drivers 130(1) to 130(k) configured to switch the k gate lines GL(1) to GL(k) into a selected state (scan) in the pixel segment Snm. Each of the gate drivers 130 is disposed between the adjacent gate lines GL, and is electrically connected to the gate drivers adjacent thereto in a Y-axis direction. FIG. 3A shows, among the gate drivers 130 in each of the gate line drive units 13, only the gate driver 130(1) for the gate line GL(1) (see FIG. 2B) to be initially switched into the selected state in each of the pixel segments.

As shown in FIG. 3A, the gate drivers 130(1) disposed in the pixel segments in a same column are connected to signal lines 151 to 153. The signal line 151 (drive line) supplies a drive signal GCK and a reset signal CLR transmitted from a display control circuit 12 to the terminal part 11. The drive signal GCK and the reset signal CLR are used by the gate driver 130 to scan the gate line GL. While this figure shows only the gate driver 130(1), the drive signal GCK is supplied to each of the gate drivers 130(1) to 130(k) in each of the pixel segments Snm (see FIG. 3B). The k gate drivers 130(1) to 130(k) in each of the pixel segments Snm thus operate in accordance with the drive signal GCK or the reset signal CLR supplied via the signal line 151.

The signal line 152 (drive control line) supplies a drive control signal Sxm (Sx1 to Sx7) transmitted from the display control circuit 12 to the terminal part 11. The drive control signal Sxm is supplied only to the gate driver 130(1). The gate drivers 130(1) disposed in the pixel segments in a same column are provided with the same drive control signal Sxm.

The signal line 153 (drive control line) supplies a drive control signal Sym (Sy1 to Sy4) transmitted from the display control circuit 12 to the terminal part 11. The drive control signal Sym is supplied only to the gate driver 130(1). The gate drivers 130(1) disposed in the pixel segments in a same row are provided with the same drive control signal Sym.

The drive control signal Sxm indicates whether or not to drive the gate line drive units 13 in which column, whereas the drive control signal Sym indicates whether or not to drive the gate line drive units 13 in which row. The drive control signal Sxm and the drive control signal Sym accordingly determine the gate line drive unit 13 in which pixel segment to be driven.

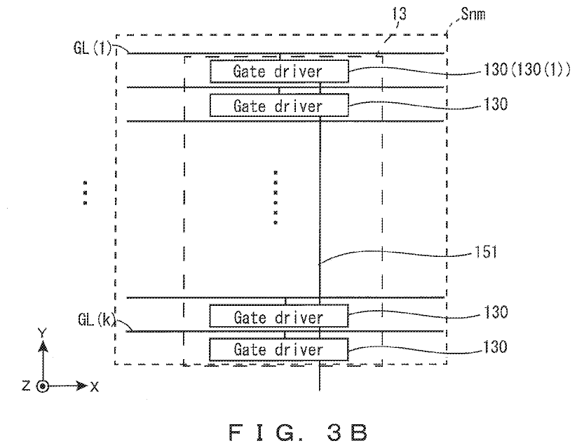

The gate drivers 130 will be described below in terms of their configuration. FIG. 4 is an equivalent circuit diagram of the gate drivers in the gate line drive unit 13 in the pixel segment Snm.

As shown in FIG. 4, the gate drivers 130(1) to 130(k) each include a plurality of thin film transistors (TFTs) (A to F) and a capacitor cbst connected together. The TFTs identified by reference signs A to F will be hereinafter referred to as a TFT-A to a TFT-F.

In the gate driver 130(j) (j is an integer and satisfying 1≤j≤k) for the gate line GL(j) in the j-th row in the pixel segment Snm, a source terminal of the TFT-A, drain terminals of the TFT-B and the TFT-C, a gate terminal of the TFT-E, and a first electrode of the capacitor cbst are connected each other. There elements are connected via an internal line hereinafter referred to as a netA(j).

In the gate driver 130(j), a second electrode of the capacitor cbst, a drain terminal of the TFT-D, a source terminal of the TFT-E, a drain terminal of the TFT-F, and the gate line GL(j) are connected each other.

In the TFT-A of the gate driver 130(1), a drain terminal thereof receives the drive control signal Sxm via the signal line 152 (see FIG. 3A), and a gate terminal thereof receives the drive control signal Sym via the signal line 153 (see FIG. 3A). In each of the gate drivers 130 other than the gate driver 130(1), the drain terminal of the TFT-A is connected to the gate line GL in a preceding row to receive potential of the gate line GL in the preceding row. The gate terminal of the TFT-A receives the drive control signal Sym via the signal line 153. Whether or not to drive the gate drivers 130 in the pixel segment Snm is determined in accordance with the drive control signals Sym and Syn received by the TFT-A in the gate driver 130(1).

In the gate driver 130(j), source terminals of the TFT-B, the TFT-C, the TFT-D, and the TFT-F are connected to a power supply circuit (not shown) connected to the active matrix substrate 10, to receive power supply voltage VSS at a low(L) level from the power supply circuit via the terminal part 11.

In each of the gate drivers 130(j) other than the gate driver 130(k), a gate terminal of the TFT-C is connected to the gate line GL(j+1) in a subsequent row to receive potential of the gate line GL(j+1).

The reset signal CLR is supplied to gate terminals of the TFT-B and the TFT-D in the gate driver 130(j), and the gate terminal of the TFT-C in the gate driver 130(k). The reset signal CLR is used to cause potential of each of the netA(j) and the gate line GL(j) to reach the power supply voltage VSS, and is transmitted from the display control circuit 12 (see FIG. 3A) to the terminal part 11.

In the gate driver 130(j), a drain terminal of the TFT-E and a gate terminal of the TFT-F each receive a clock signal CKAm or CKBm as the drive signal GCK, via the signal line 151 (see FIG. 3A). Each of the clock signals CKAm and CKBm is a voltage signal having potential alternately reaching a high (H) level and the L level repeatedly at a certain interval during a scan interval for a single pixel segment. The clock signals CKAm and CKBm are opposite to each other in phase.

Exemplified herein is a case where the clock signal CKAm is received by the drain terminal of the TFT-E in each of the gate drivers 130 for the gate lines GL in odd rows, and the clock signal CKBm is received by the gate terminal of the TFT-E Meanwhile, the drain terminal of the TFT-E and the gate terminal of the TFT-F in each of the gate drivers 130 for the gate lines GL in even rows receive the clock signals having phases opposite to the phases of the clock signals received by the gate drivers 130 in the odd rows.

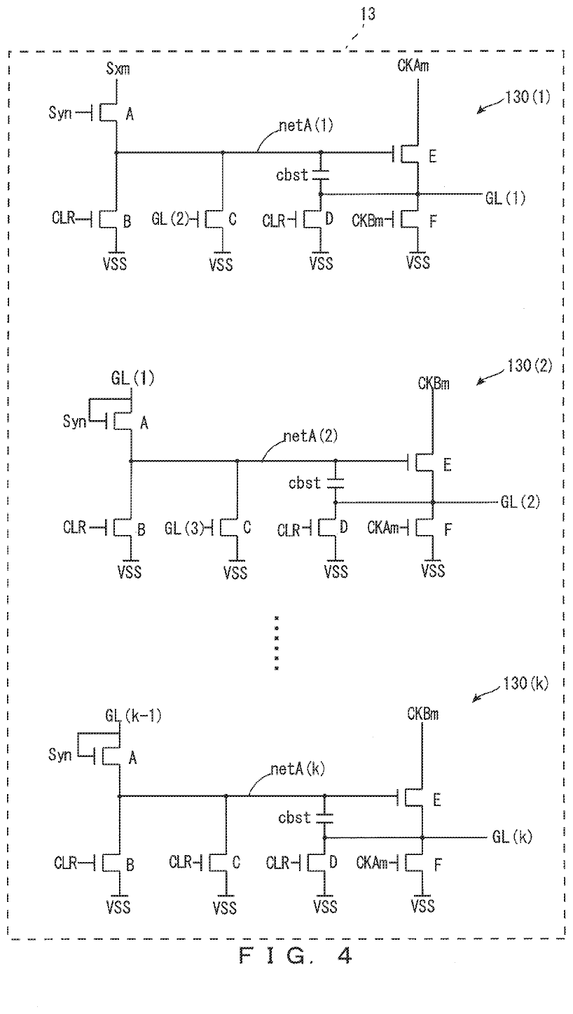

The gate drivers 130 in the pixel segment Snm will be described next in terms of disposition thereof. FIG. 5 is a pattern diagram showing disposition of the gate drivers 130(1) to 130(k) in the pixel segment Snm.

As shown in FIG. 5, the pixels pix in the pixel segment Snm are each provided with a pixel electrode 161 and a TFT 162 connected to the gate line GL, the data line SL, and the pixel electrode 161. The elements of the gate driver 130(j) are dispersed across the plurality of pixels pix between the adjacent gate lines GL and are positioned so as not to be overlapped with the TFT 162.

Each of the signal lines 151 to 153 extends substantially in parallel with the data lines SL from the terminal part 11 (see FIG. 3A and the like) and extends substantially in parallel with the gate line GL to reach a pixel provided with the TFT to be connected. The signal line 151 is connected to each of the gate drivers 130(1) to 130(k), whereas each of the signal lines 152 and 153 is connected only to the TFT-A in the gate driver 130(1).

The gate drivers 130(1) to 130(k) in the pixel segment Snm will be described next in terms of operation thereof.

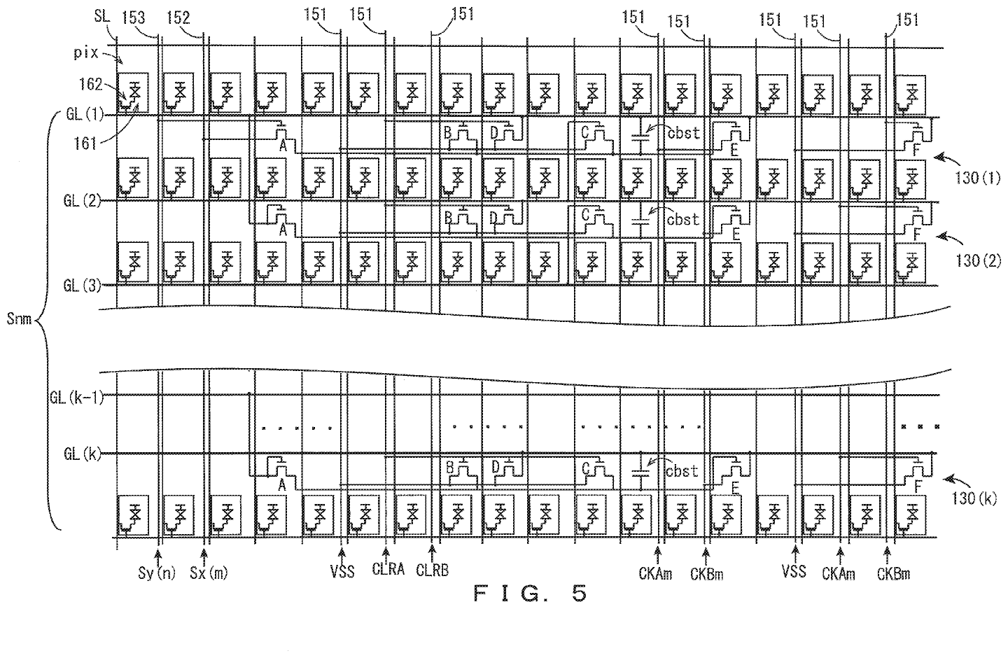

FIG. 6 is a timing chart indicating potential variation of the drive control signals, the clock signals, the reset signal, as well as the netA in each of the gate drivers 130(1) to 130(k) and the gate lines GL(1) to GL(k).

As indicated in FIG. 6, each of data signals D1 to Dk is supplied to the data lines SL during the scan interval for the gate lines GL in the single pixel segment Snm.

The drive control signals Sym and Syn each have potential reaching the H level prior to scan start timing t0 for the gate lines GL in the pixel segment Snm, and then transitioning to the L level. From the timing t0 to timing tk while the potential of each of the drive control signals Sym and Syn transitions to the L level, the clock signals CKA and CKB have potential repeatedly reaching the H level and the L level to be opposite to each other in phase.

When the potential of each of the drive control signals Sym and Sym reaches the H level, the TFT-A in the gate driver 130(1) comes into an ON state. The remaining TFTs are in an OFF state in this case, so that the netA(1) is charged to have potential at the H level.

If the potential of the clock signal CKA reaches the H level at the timing t0, the clock signal CKA inputted via the drain terminal of the TFT-E causes the gate line GL(1) to start being charged.

When the gate line GL(1) starts being charged, the potential of the netA(1) is raised via the capacitor cbst and higher voltage is applied to the gate terminal of the TFT-E. The gate line GL(1) is then charged to have potential at the H level. While the potential of the gate line GL(1) is at the H level, image data according to the data signal D1 supplied to the data line SL is written to the pixel defined by the gate line GL(1) and the data line SL.

If the potential of the clock signal CKA reaches the L level and the potential of the clock signal CKB reaches the H level at timing t1, the TFT-F comes into the ON state. The gate line GL(1) then discharges to reach potential of the power supply voltage VSS.

The drain terminal of the TFT-A in the gate driver 130(2) receives the potential at the H level of the gate line GL(1) at the timing t0, and the netA(2) and the gate line GL(2) are charged as in the gate driver 130(1).

At the timing t1 when the potential of the gate line GL(2) reaches the H level, the TFT-C in the gate driver 130(1) comes into the ON state and the netA(1) reaches the potential of the power supply voltage VSS. The potential of the netA(j) in the gate driver 130(j) transitions from the H level to the L level at timing when the potential of the gate line GL(j+1) in the subsequent row reaches the H level.

In this manner, the gate drivers 130(1) to 130(k) are sequentially driven to sequentially charge the gate lines GL(1) to GL(k) to have potential at the H level, and image data according to each of the data signals D1 to Dk is written to the pixel segment Snm. At the timing tk when the potential of the gate line GL(k) transitions from the H level to the L level, the gate terminals of the TFT-B and the TFT-D in each of the gate drivers 130(1) to 130(k) and the TFT-C in the gate driver 130(k) receive the reset signal CLR having potential at the H level. From the timing tk, the potential of the netA(k) in the gate driver 130(k) accordingly reaches the power supply voltage VSS. The potential of the netA(1) to the netA (k−1) in the gate drivers 130(1) to 130(k−1) and the gate lines GL(1) to GL(k) is kept at the power supply voltage VSS.

In the case where the TFT-A in the gate driver 130(1) in the pixel segment Snm receives the drive control signals Sxm and Sym having potential at the H level, the gate drivers 130(1) to 130(k) in the pixel segment Snm are sequentially driven to scan the gate lines GL(1) to GL(k). Only the gate drivers 130 in a predetermined pixel segment can thus be driven to have data written to the pixel segment, with no data written to the remaining pixel segments. This enables data to be written to the respective pixel segments at frequencies different from one another.

Described below is exemplary data writing according to the present embodiment.

### (Example 1) when Writing Data Only to Single Pixel Segment During Single Frame

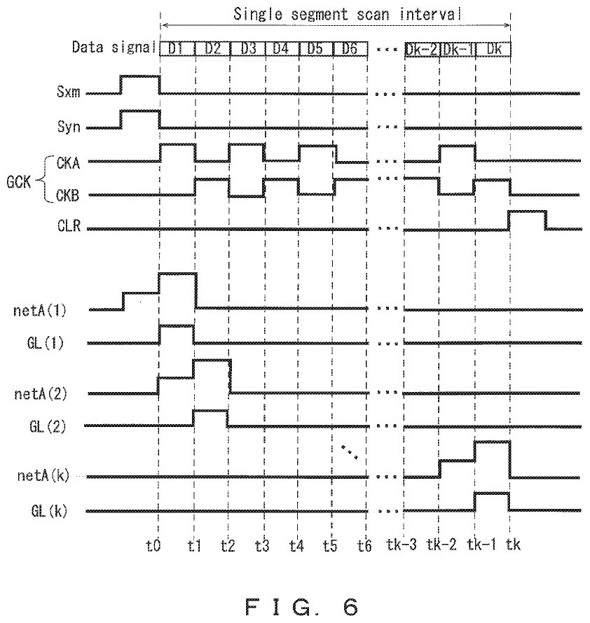

FIG. 7 is a timing chart of the drive control signals, the clock signals, and the reset signals upon having data written to the pixel segment S23 shown in FIG. 2A.

As shown in FIG. 7, a data writing period (single frame) for the display region R shown in FIG. 2A is divided into data writing periods (T1 to T4) for the pixel segments in the rows n=1 to 4.

Exemplified herein is the case where the pixel segments in the odd rows (n=1, 3) each receive a reset signal CLR1 whereas the pixel segments in the even rows (n=2, 4) each receive a reset signal CLR2. The gate driver 130(k) in the pixel segment S23 accordingly receives the reset signal CLR2.

As shown in FIG. 7, before start timing t11 of the data writing period T2, the potential of each of the drive control signal Sx3 for the pixel segment Sn3 in the column m=3 and the drive control signal Sy2 for the pixel segment S2m in the second row reaches the H level. The drive control signal Sx1, Sx2, and Sx4 to Sx7 and the drive control signals Sy1, Sy3, and Sy4 other than the drive control signals Sx3 and Sy2 each have potential at the L level in this case. This brings, into the ON state, only the TFT-A in the gate driver 130(1) in the pixel segment S23.

From the timing t11, the clock signals CKA and CKB are supplied to the gate drivers 130 in all the pixel segments. Only the gate drivers 130(1) to 130(k) in the pixel segment S23 are thus sequentially driven to scan the gate lines GL(1) to GL(k) in the pixel segment S23. Image data according to a data signal received by the data lines SL during the data writing period T2 is thus written to the pixel segment S23.

The reset signal CLR1 has potential reaching the H level at the data writing start timing t11 for the pixel segments S2m in the second row and at data writing start timing t14 for the pixel segments S4m in the fourth row. The reset signal CLR2 has potential reaching the H level at the data writing start timing t14 for the pixel segments S1m in the first row and at data writing start timing t13 for the pixel segments S3m in the third row. After the gate line GL(k) in the pixel segment S23 is scanned, the reset signal CLR2 causes the potential of the netA(k) in the gate driver 130(k) in the pixel segment S23 to reach the L level.

Each of the gate drivers 130 in the pixel segments in the row n=4 also receives the reset signal CLR2, and each of the gate drivers 130 in the pixel segments in the rows n=1, 3 receives the reset signal CLR1. Accordingly, the netA in each of these gate drivers 130 and the gate lines GL in the pixel segments in the rows n=1, 3, 4 each have potential kept at the L level.

The above exemplary case includes inputting the reset signal CLR2 as well as the reset signal CLR1. The gate lines in the pixel segment not expected to have data written thereto and the netA in each of the gate drivers in the pixel segment can thus have potential reliably kept at the L level. The pixel segment expected to have data written thereto has only to be configured to receive a reset signal after the gate lines GL in the pixel segment are scanned.

### (Example 2) when Writing Data to Plurality of Pixel Segments in Different Rows During Single Frame

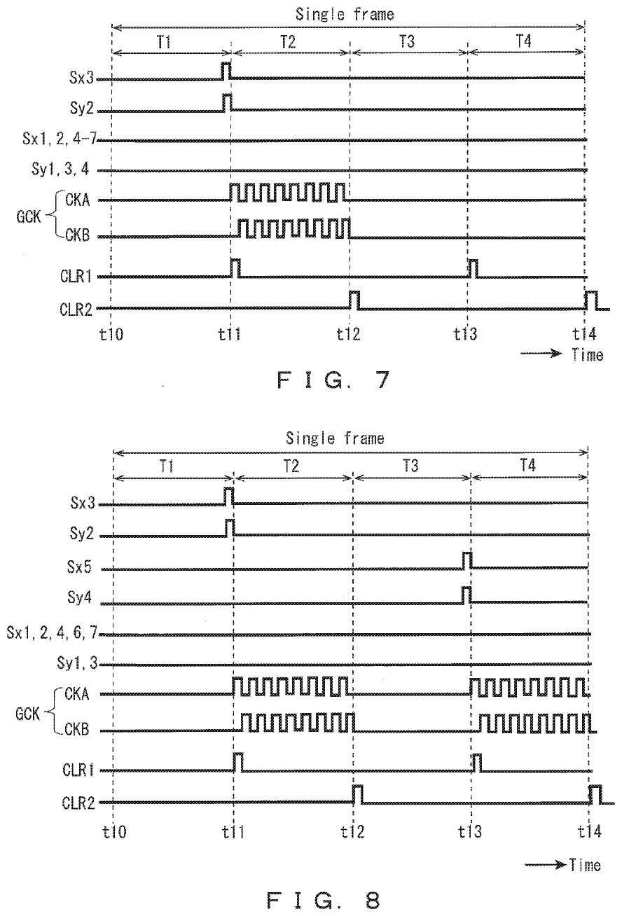

In an exemplary case where data is written to the pixel segment S23 as in the example 1 and the pixel segment S45 shown in FIG. 2A, the drive control signals, the clock signals, and the reset signals need to be inputted as indicated in FIG. 8. Points different from those according to the example 1 will be mainly described below.

In this case, as in the example 1, after the gate lines GL in the pixel segment 23 are scanned, the potential of each of the clock signals CKA and CKB is kept at the L level until the data writing start timing t13 of the data writing period T4.

Before the start timing t13 of the data writing period T4, the potential of each of the drive control signals Sy4 and Sx5 for the pixel segments S4m in the row n=4 and the pixel segments Sn5 in the column m=5 reaches the H level whereas the potential of each of the drive control signals Sx1 to Sx4, Sx6, and Sx7 and the drive control signals Sy1 to Sy3 for the pixel segments in the remaining columns and the remaining rows reaches the L level. This brings, into the ON state, only the TFT-A in the gate driver 130(1) in the pixel segment S45.

All the gate drivers 130 are subsequently supplied with the clock signals CKA and CKB each having potential alternately reaching the H level and the L level repeatedly during the data writing period T4. The gate drivers 130(1) to 130(k) in the pixel segment S45 are accordingly sequentially driven to sequentially scan the gate lines GL(1) to GL(k) in the pixel segment S45. Image data according to a data signal received by the data lines SL during the period T4 is thus written to the pixel segment S45.

After the gate line GL(k) in the pixel segment S45 is scanned, the gate driver 130(k) in the pixel segment S45 receives the reset signal CLR2 having potential at the H level and the netA(k) in the gate driver 130(k) has potential at the L level.

### (Example 3) when Writing Data to all Pixel Segments During Single Frame

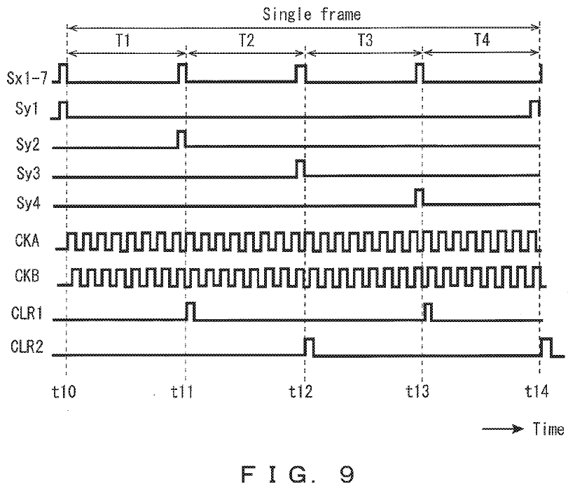

FIG. 9 is a timing chart indicating potential variation of drive control signals, clock signals, and reset signals upon having data written to all the pixel segments. As shown in FIG. 9, the potential of all the drive control signals Sx1 to Sx7 reaches the H level before the start of the data writing periods (T1 to T4) for the pixel segments in the respective rows, whereas the potential reaches the L level during the remaining periods. The potential of each of the drive control signals Sy1 to Sy4 for the pixel segments in the first to fourth rows reaches the H level before the start of the data writing periods for the respective rows, whereas the potential reaches the L level during the remaining periods. This brings, into the ON state, the TFT-As in the gate drivers 130(1) in the pixel segments in the first to fourth rows in the mentioned order.

The potential of the clock signals CKA and CKB alternately reaches the H level and the L level repeatedly to be opposite to each other in phase during the data writing periods (T1 to T4). The gate drivers 130(1) to 130(k) in the pixel segments are sequentially driven in the first to fourth rows in the mentioned order to scan the gate lines GL(1) to GL(k) in the pixel segments. Image data according to a data signal received by the data lines SL during each of the data writing periods T1 to T4 is thus sequentially written to each of the pixel segments in the first to fourth rows.

In a case where data is not written to all the pixel segments during a single frame, the drive control signals Sxm and Sym, the clock signals CKA and CKB, and the reset signals CLR1 and CLR2 each need to have potential at the L level during the single frame. The gate drivers 130 in all the pixel segments accordingly stop so as not to have data written to the pixel segments.

According to the first embodiment described above, the gate line drive unit 13 in which one of the plurality of pixel segments in the display region is driven is determined in accordance with the drive control signals Sxm and Syn so as to have data written only to the pixel segment. The gate line drive unit 13 in the pixel segment not expected to have data written thereto can then be stopped to reduce electric power consumed for driving the gate line drive unit 13.

### Second Embodiment

The above first embodiment exemplifies the case where all the gate drivers 130 are simultaneously supplied with the clock signals CKA and CKB having potential alternately reaching the H level and L level repeatedly. In the first embodiment, the clock signals CKA and CKB having potential alternately reaching the H level and the L level repeatedly need to be supplied to all the gate drivers 130 even in a case of driving only the gate drivers 130 in a single pixel segment in each row, failing to achieve reduction in electric power consumed for supplying the clock signals CKA and CKB. The present embodiment provides a configuration achieving reduction in electric power consumed for supplying the clock signals CKA and CKB as well as reduction in electric power consumed for driving the gate drivers 130.

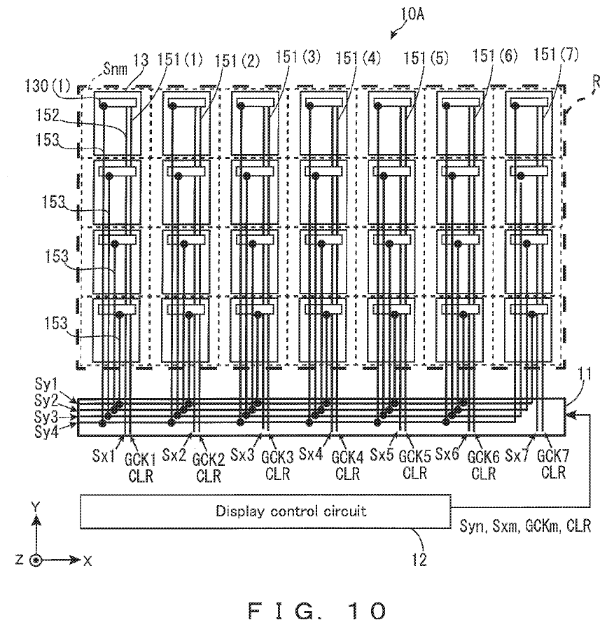

FIG. 10 is a plan view showing a schematic configuration of an active matrix substrate 10A according to the present embodiment. In FIG. 10, components similar to those according to the first embodiment are denoted by reference signs common with the first embodiment. Configurations different from those according to the first embodiment will be mainly described below.

As shown in FIG. 10, the active matrix substrate 10A includes pixel segments in the columns m=1 to 7 supplied with a common drive signal GCKm and the reset signal CLR by the column via the terminal part 11. Described below is exemplary data writing according to the present embodiment.

### (Example 1) when Writing Data Only to Single Pixel Segment During Single Frame

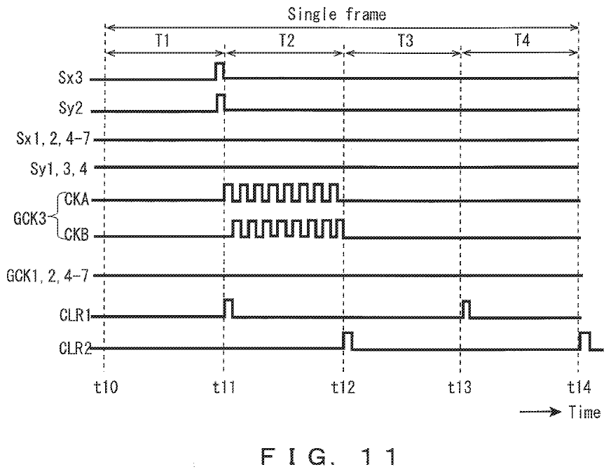

FIG. 11 is a timing chart indicating potential variation of drive control signals, clock signals, and reset signals upon having data written only to the pixel segment S23 shown in FIG. 2A as in the example 1 of the first embodiment. Points different from those according to the example 1 of the first embodiment will be mainly described below.

As shown in FIG. 11, during the data writing period T2 for the pixel segments in the second row, the gate drivers 130 in the pixel segments in the third column are supplied with, as the drive signal GCK3, the clock signals CKA and CKB having potential alternately reaching the H level and the L level repeatedly to be opposite to each other in phase. The gate drivers 130 in the pixel segments in the columns other than the third column are supplied with the clock signals CKA and CKB having potential at the L level, as the drive signals GCK1, GCK2, and GCK4 to GCK7. In this case, during the data writing period T2 in the single frame, the potential of the clock signals CKA and CKB needs to alternately transition between the H level and the L level only for the drive signal GCK3.

### (Example 2) when Writing Data to Plurality of Pixel Segments in Different Rows During Single Frame

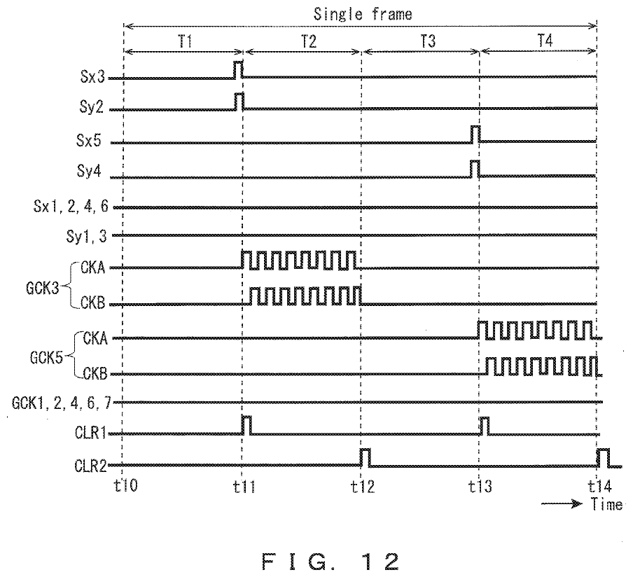

FIG. 12 is a timing chart indicating potential variation of drive control signals, clock signals, and reset signals upon having data written to the pixel segment S23 and the pixel segment S45 as in the example 2 of the first embodiment. Points different from those according to the example 2 of the first embodiment will be mainly described below.

As indicated in FIG. 12, during the data writing period T4 for the pixel segments in the fourth row, the gate drivers 130 in the pixel segments in the fifth column are supplied with, as the drive signal GCK5, the clock signals CKA and CKB having potential alternately reaching the H level and the L level repeatedly to be opposite to each other in phase. The gate drivers 130 in the pixel segments in the columns other than the fifth column are supplied with the clock signals CKA and CKB having potential at the L level, as the drive signals GCK1 to GCK4, GCK6, and GCK7. In this case, the potential of the clock signals CKA and CKB needs to alternately transition between the H level and the L level only for the drive signal GCK3 during the data writing period T2 and only for the drive signal GCK5 during the data writing period T4 in the single frame.

### (Example 3) when Writing Data to all Pixel Segments During Single Frame

In the present embodiment, the clock signals similar to those according to the example 3 of the first embodiment may be supplied to have data written to all the pixel segments. In the case of writing data to all the pixel segments, the gate drivers 130 in all the pixel segments are supplied with the clock signals CKA and CKB having potential alternately reaching the H level and the L level repeatedly to be opposite to each other in phase, as the drive signals GCK1 to GCK7 during the single frame. The gate drivers 130 in the pixel segments are driven by the row during the data writing periods T1 to T4 to have image data written.

The present embodiment needs control similar to that according to the first embodiment in a case where data is not written to all the pixel segments. The gate drivers 130 in all the pixel segments need to be supplied with the clock signals CKA and CKB having potential at the L level as the drive signals GCK1 to GCK7 during the single frame.

The second embodiment described above includes simultaneously suppling the common drive signal GCK by the column of the pixel segments, without including supplying the clock signals CKA and CKB having potential alternately reaching the H level and L level repeatedly to the pixel segments in the column not to have data written thereto. Similarly to the first embodiment, this configuration achieves reduction in electric power consumed for supplying the drive signal GCK in comparison to a case where the common drive signal GCK is supplied to the pixel segments in all the columns.

### Third Embodiment

The second embodiment described above exemplifies the case where the gate drivers 130 in the pixel segments are driven by the row to have data written thereto. The present embodiment relates to a case of simultaneously driving the gate drivers 130 in a plurality of pixel segments to have same data written thereto.

Specifically, the present embodiment exemplifies a case where the active matrix substrate 10A has data written at frequencies different from each other between a plurality of pixel segments in a bold frame Q and the pixel segments other than the plurality of pixel segments. The bold frame Q includes six pixel segments, namely, the pixel segments S23 to S25 and S32 to S35 shown in FIG. 2A. Data writing to the six pixel segments S23 to S25 and S32 to S35 is updated during each frame, whereas the remaining pixel segments have data written thereto only during the first frame without update of data writing in the second and subsequent frames.

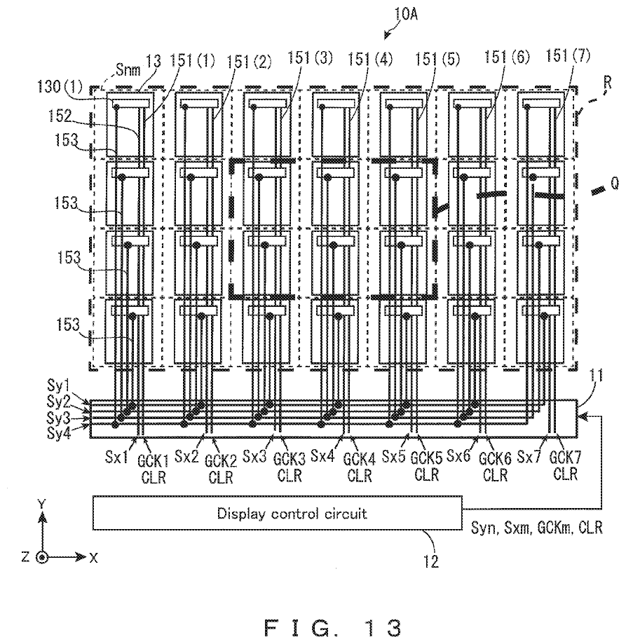

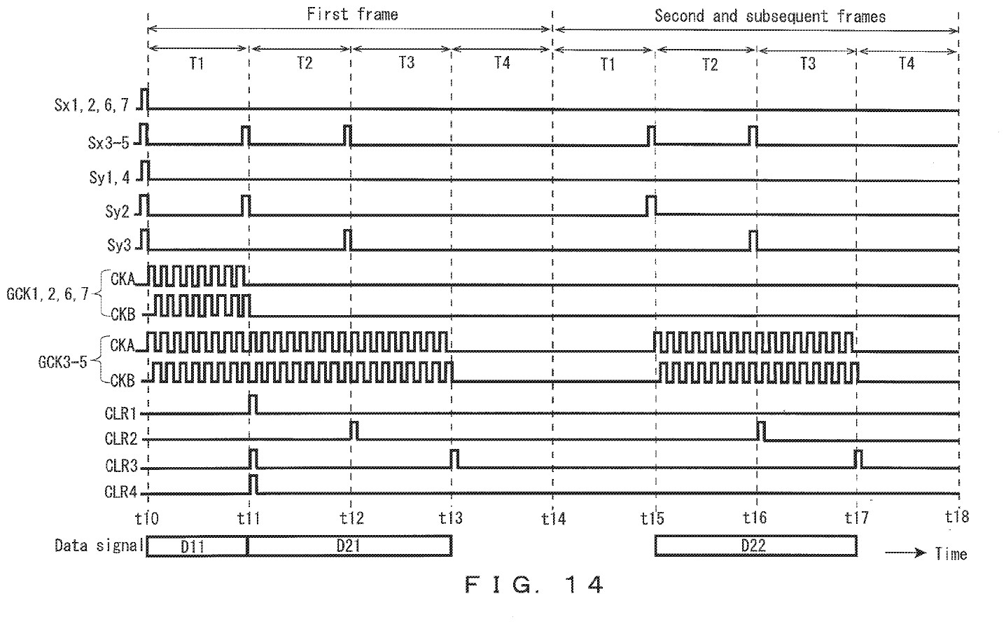

FIG. 14 is a timing chart indicating data writing to the pixel segments in the active matrix substrate 10A shown in FIG. 13. FIG. 14 exemplifies reset signals CLR1 to CLR4 for the gate drivers 130 in the pixel segments in the first to fourth rows, respectively. As shown in FIG. 14, the potential of each of the drive control signals Sx1 to Sx7 and Sy1 to Sy4 reaches the H level before the start of data writing during the first frame. During the data writing period T1 (t10 to t11), the gate drivers 130 in the pixel segments in the respective columns are supplied with, as the drive signals GCK1 to GCK7, the clock signals CKA and CKB having potential alternately reaching the H level and the L level repeatedly to be opposite to each other in phase.

This brings the TFT-As in the gate drivers 130(1) in all the pixel segments into the ON state at the start of the first frame, and the gate drivers 130 in the pixel segments in the respective columns are driven in accordance with the drive signals GCK1 to GCK7 to scan the gate lines GL in the pixel segments. The data lines SL (see FIG. 2B and the like) are supplied with the data signal D11 in this case, so that image data (e.g. a black image) according to the data signal D11 is substantially simultaneously written to all the pixel segments.

When the gate line GL(k) in the last row is scanned in each of the pixel segments, the potential of each of the reset signals CLR1, CLR3, and CLR4 for the gate drivers 130 in the pixel segments in the rows n=1, 3, and 4 reaches the H level. This brings, into the L level, the potential of the gate lines GL in the pixel segments in the first, third, and fourth rows.

The drive control signals Sx3 to Sx5 for the gate drivers 130(1) in the pixel segments in the third to fifth columns each have potential reaching the H level again at the start of the data writing periods T2 and T3. The drive control signal Sy2 for the gate drivers 130(1) in the pixel segments in the second row has potential reaching the H level again at the start of the data writing period T2. The drive signals GCK3 to GCK5 for the gate drivers 130 in the pixel segments in the third to fifth columns each have potential alternately reaching the H level and the L level repeatedly during the data writing period T2. This brings, into the ON state, only the TFT-As in the gate drivers 130 in the pixel segments S23 to S25 in the second row at the start of the data writing period T2. The gate drivers 130 in the pixel segments S23 to S25 are then driven to scan the gate lines GL in the pixel segments S23 to S25. Image data according to the data signal D21 supplied to the data lines SL is written to the pixel segments S23 to S25 in this case.

After the data writing period T2, the gate drivers 130 in the pixel segments S23 to S25 each receive the reset signal CLR2 having potential at the H level. This brings the potential of the gate lines GL in the pixel segments S23 to S25 into the L level after the data writing period T2.

At the start of the data writing period T3, the drive control signals Sx3 to Sx5 and the drive control signal Sy3 for the gate drivers 130(1) in the pixel segments in the third row each have potential reaching the H level again. The drive signals GCK3 to GCK5 each have potential alternately reaching the H level and the L level repeatedly during the data writing period T3. This brings, into the ON state, only the TFT-As in the gate drivers 130(1) in the pixel segments S33 to S35 in the third row at the start of the data writing period T3. The gate drivers 130 in the pixel segments S33 to S35 are then driven to scan the gate lines GL in the pixel segments S33 to S35. Image data according to the data signal D21 supplied to the data lines SL is written to the pixel segments S33 to S35 in this case.

After the data writing period T3, the gate drivers 130 in the pixel segments S33 to S35 each receive the reset signal CLR3 having potential at the H level. This brings the potential of the gate lines GL in the pixel segments S33 to S35 into the L level after the data writing period T3.

From the start of the first frame, the drive control signals Sx1, Sx2, Sx6, and Sx7 as well as the drive control signals Sy1 and Sy4 each have potential kept at the L level. The drive signals GCK1, GCK2, GCK6, and GCK7 each have potential at the L level from the data writing period T1. The gate drivers 130 in the pixel segments other than the pixel segments S23 to S25 and S33 to S35 are driven only during the data writing period T1 in the first frame and are not driven after the data writing period T1.

By the start of the data writing period T4 in the first frame, the pixel segments each have data for the first frame written thereto. Accordingly, the drive control signals Sx1 to Sx7 and Sy1 to Sy4 as well as the drive signals GCK1 to GCK7 each have potential at the L level during the data writing period T4. The data lines SL are not supplied with any data signal during this period. During the data writing period T4, the gate drivers 130 in all the pixel segments are not driven and the pixel segments each keep the data written by the data writing period T3. None of the pixel segments has data written thereto during the data writing period T4.

During the second and subsequent frames, the drive control signals Sx1, Sx2, Sx6, and Sx7, the drive control signals Sy1 and Sy4, and the drive signals GCK1, GCK2, GCK6, and GCK7 each have potential kept at the L level. The gate drivers 130 in the pixel segments other than the pixel segments S23 to S25 and S33 to S35 are thus not driven during the second and subsequent frames and are each kept with the image data according to the data signal D11 written thereto.

The potential of each of the drive control signals Sx3 to Sx5 reaches the H level before the start of the data writing periods T2 and T3 in each of the second and subsequent frames. During each of the second and subsequent frames, the potential of only the drive control signal Sy2 reaches the H level before the start of the data writing period T2, and the potential of only the drive control signal Sy3 reaches the H level before the start of the data writing period T3. The drive signals GCK3 to GCK5 each have potential alternately reaching the H level and the L level repeatedly during the data writing periods T2 and T3.

None of the pixel segments has data written thereto during the data writing period T1 in each of the second and subsequent frames. During the data writing period T2 in each of the second and subsequent frames, only the gate drivers 130 in the pixel segments S23 to S25 are driven to scan the gate lines GL in the pixel segments S23 to S25. During the data writing period T3 in each of the second and subsequent frames, only the gate drivers 130 in the pixel segments S33 to S35 are driven to scan the gate lines GL in the pixel segments S33 to S35.

Image data according to the data signal D22 supplied to the data lines SL during the data writing periods T2 and T3 in each of the second and subsequent frames is written to the pixel segments S23 to S25 during the data writing period T2 and is written to the pixel segments S33 to S35 during the data writing period T3.

After the data writing period T2, the potential of the reset signal CLR2 reaches the H level, and the potential of the netA in each of the gate drivers 130 and the gate lines GL(k) in the pixel segments S23 to S25 reaches the L level. After the data writing period T3, the potential of the reset signal CLR3 reaches the H level, and the potential of the netA in each of the gate drivers 130 and the gate lines GL(k) in the pixel segments S33 to S35 reaches the L level. Exemplified herein is the case where the reset signals CLR2 and CLR3 each have potential at the L level during the periods T4 and T1 (in the second and subsequent frames) having no data writing. The reset signals CLR2 and CLR3 may alternatively be controlled to have potential alternately reaching the H level in each of the data writing periods T1 to T4 also after the period having no data writing. This enables the gate drivers 130 to be stopped more reliably in the pixel segment having no data written thereto.

The above exemplary configuration achieves updating data writing in each frame only in the region of the bold frame Q and constantly displaying a black image in the remaining region. Application of such display control to a mobile device like a portable terminal in a standby mode enables the mobile terminal to be driven with low electric power consumption.

The third embodiment described above includes simultaneously writing same data to all the pixel segments at the start of the first frame and not updating data writing to the pixel segments other than the six pixel segments S23 to S25 and S33 to S35 during the second and subsequent frames. This shortens time for supplying the drive signal GCK to the gate drivers 130 in the respective pixel segments in comparison to a case of writing data to the pixel segments by the row. It is accordingly possible to reduce electric power consumed for supplying the drive signal GCK.

### Modification Examples

The embodiments of the present invention described above are merely exemplified for implementation of the present invention. The present invention should not be limited to the embodiments described above, and can be implemented with appropriate modifications to the above embodiments without departing from the spirit of the present invention.

(1) The above first to third embodiments each exemplify the display panel 100 configured by a liquid crystal panel. The display panel 100 may alternatively adopt an organic electro-luminescence (EL) or the like.

1. A display panel comprising an active matrix substrate, the active matrix substrate includes:
a substrate;
a plurality of gate lines provided in a plurality of pixel segments arrayed in a matrix form on the substrate, including a plurality of gate lines provided in each of the pixel segments;
a plurality of data lines crossing the plurality of gate lines;
a plurality of gate line drive circuitry provided respectively in the plurality of pixel segments; and
a drive control line connected to each of the gate line drive circuitry to be supplied with a drive control signal indicating drive or stop of the gate line drive circuitry,
wherein at least one gate line drive circuitry connected to the drive control line having been supplied with the drive control signal indicating drive scans the gate lines in the pixel segment provided with the at least one gate line drive circuitry.

2. The display panel according to claim 1, wherein
the active matrix substrate further includes
a plurality of drive lines connected respectively to the plurality of gate line drive circuitry to each supply a drive signal used for scanning the gate lines by a corresponding one of the gate line drive circuitry, and
the drive lines are simultaneously supplied with the drive signal in common.

3. The display panel according to claim 1, wherein
the active matrix substrate further includes
a plurality of drive lines each provided for each column of the plurality of pixel segments, connected to the gate line drive circuitry provided in the column, and configured to supply a drive signal used for scanning the gate lines by the gate line drive circuitry, and
the drive signal is supplied only to the drive line connected to the gate line drive circuitry in the column of the pixel segments provided with the gate line drive circuitry receiving the drive control signal indicating drive.

4. The display panel according to claim 1, wherein the gate line drive circuitry provided in the plurality of pixel segments arrayed in each row are simultaneously supplied with the drive control signal in common.

5. The display panel according to claim 1, wherein the plurality of gate line drive circuitry is simultaneously supplied with the drive control signal in common.
